(19) United States
(12) Patent Application Publication
(10) Pub. No.: US 2018/0313370 A1
(43) Pub. Date: Nov. 1, 2018

(54) ELECTRO-PNEUMATIC MODULAR MANIFOLD FOR THE CONTROL OF A PNEUMATICALLY ACTUATED ACCESS MECHANISM

(71) Applicant: Upwardor Inc., Milton (CA)

(72) Inventor: Ryan GREEN, Brampton (CA)

(73) Assignee: Upwardor Inc.

(21) Appl. No.: 15/581,313

(22) Filed: Apr. 28, 2017

(51) Int. Cl. F15B 13/08; F15B 15/22

(52) U.S. Cl. CPC F15B 13/0814; F15B 13/085; F15B 15/22; F15B 13/086; F15B 13/0871

(57) ABSTRACT

A pneumatic manifold with internal and external porting is machined in a specific sequence for pressurized and exhausting air control. Electro-pneumatic valves and or blocking plates are fastened and sealed to the positions of exterior porting. The electro-pneumatic valves complete the pneumatic circuit already machined in the manifold. Electro-pneumatic valves can be added or removed depending on the required functions. Other exterior ports on the manifold allow for but are not limited to connection of a pressure transducer, exterior pilot feeds, individual open/close speed controls, individual secondary slow down speed controls for open and close. The manifold allows the mounting of three electro-pneumatic valves wherein each valve controls a certain specific sequential function. When used with a compatible means of electronic control, the manifold can replace most pneumatic control devices driving a pneumatic actuator for the purpose of moving an access mechanism, such as a garage door.

### FIELD OF THE INVENTION

This invention relates to the field of door operators. More specifically, the invention compromises a manifold and electro-pneumatic devices for the control of a pneumatic actuator to control an access mechanism such as a garage door.

### BACKGROUND OF THE INVENTION

There are many known electro-pneumatic devices and configurations to control a pneumatic actuator which itself, opens or closes an access mechanism, such as a garage door. These electro-pneumatic configurations typically consist of a control valve or valves which are plumbed together with threaded mechanical fittings and tubing. The exhausting air is manipulated by the electro-pneumatic valves and manual flow limiting devices for control of the pneumatic actuator.

Various pneumatic control circuits require increasingly larger enclosure volumes to house the apparatus. Due to complexity and space limitations for these pneumatic control circuits some functions are limited such as the number of primary speed controls, the number of cushion or slow down speed controls, the number of exhaust to atmosphere controls and monitoring devices. Current pneumatic controls in the related field of this invention are also limited to open, close and reverse functions.

In one embodiment of the present invention, a pneumatic control circuit can be implemented in one body with the ability to add or remove electro-pneumatic valves depending on the required function. This is beneficial in regards to:
(a) Having the ability of stopping the access mechanism in any position;
(b) Allowing smaller enclosure volumes for housing apparatus of more complicated pneumatic circuits;
(c) Being less prone to unsafe failure and or degradation of joints, joint seals and tubing;
(d) Easier servicing or part replacement as there are far less components to physically remove, replace or add; and
(e) Lower decibel levels of exhausting air due to the baffling effect of the manifold porting when used in conjunction with a porous silencer.

### SUMMARY OF THE INVENTION

It will be appreciated by those skilled in the art that other variations of the embodiments described below may also be practiced without departing from the scope of the invention. Further note, these embodiments, and other embodiments of the present invention, will become more fully apparent from a review of the description and claims which follow. In one embodiment, the present invention is comprised of a pneumatic manifold with internal and external porting machined in a specific sequence for pressurized and exhausting air control. Electro-pneumatic valves and or blocking plates are fastened and sealed with a gasket or o-ring to the positions of exterior porting. The electro-pneumatic valves complete the pneumatic circuit already machined in the manifold. Electro-pneumatic valves can be added or removed depending on the required functions. Other exterior ports on the manifold allow for but are not limited to connection of a pressure transducer, exterior pilot feeds, individual open/close speed controls, individual secondary slow down speed controls for open and close.

In one embodiment, the present invention allows the mounting of three electro-pneumatic valves. Each valve controls a certain specific sequential function. The primary 5 port, 3 position inlet open to cylinder ports valve allows directional control of the pressurized air and stop control of the pneumatic actuator. A secondary 5 port 2 position valve diverts exhausting air before the primary individual manually adjustable restriction valves from the controlled pneumatic circuit to atmosphere for improving initial acceleration upon movement of the pneumatic actuator in either direction. Another secondary 5 port 2 position valve diverts exhausting air from the controlled pneumatic circuit to secondary individual manually adjustable flow restriction valves for deceleration of the pneumatic actuator in either direction.

The present invention, when used with a compatible means of electronic control such as a printed circuit can be used to replace most pneumatic control devices driving a pneumatic actuator for the purpose of moving an access mechanism. Further aspects and advantages of the present invention will become apparent from the following description taken together with the accompanying drawings.

### BRIEF DESCRIPTION OF THE DRAWINGS

FIG. 1 is a perspective view of the manifold with electro-pneumatic valves and manual exhaust flow restriction valve assemblies attached in accordance with one embodiment of the present invention.

FIG. 2 is a perspective view of the manifold showing external connection ports for regulated pressurized air inlets, outlets and the exhausting air outlet in accordance with one embodiment of the present invention.

FIG. 3 is a perspective view of a typical manifold porting with electro-pneumatic valves and manual exhaust flow restriction valve assemblies removed in accordance with one embodiment of the present invention.

FIG. 4 is a pneumatic diagram for open, close, stop, acceleration and deceleration control assembled with all electro-pneumatic valves and manual exhaust flow restriction valve assemblies in accordance with one embodiment of the present invention.

FIG. 5 is a pneumatic diagram for open, close, stop and deceleration control assembled with the appropriate electro-pneumatic valves and manual exhaust flow restriction valve assemblies in accordance with one embodiment of the present invention.

FIG. 6 is a pneumatic diagram for open, close and stop control assembled with the appropriate electro-pneumatic valve and manual exhaust flow restriction valve assembly in accordance with one embodiment of the present invention.

In the drawings, preferred embodiments of the invention are illustrated by way of example. It is to be expressly understood that the drawings are only for the purpose of illustration and as an aid to understanding, and are not intended as a definition of the limits of the invention.

### DETAILED DESCRIPTION OF PREFERRED EMBODIMENTS

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. In particular, all terms used herein are used in accordance with their ordinary meanings unless the context or definition clearly indicates otherwise. Also, unless indicated otherwise except within the claims the use of “or” includes “and” and vice-versa. Non-limiting terms are not to be construed as limiting unless expressly stated or the context clearly indicates otherwise (for example, “including”, “having”, “characterized by” and “comprising” typically indicate “including without limitation”). Singular forms included in the claims such as “a”, “an” and “the” include the plural reference unless expressly stated or the context clearly indicates otherwise. Further, the stated features and/or configurations or embodiments thereof the suggested intent may be applied as seen fit to certain operating conditions or environments by one experienced in the field of art.

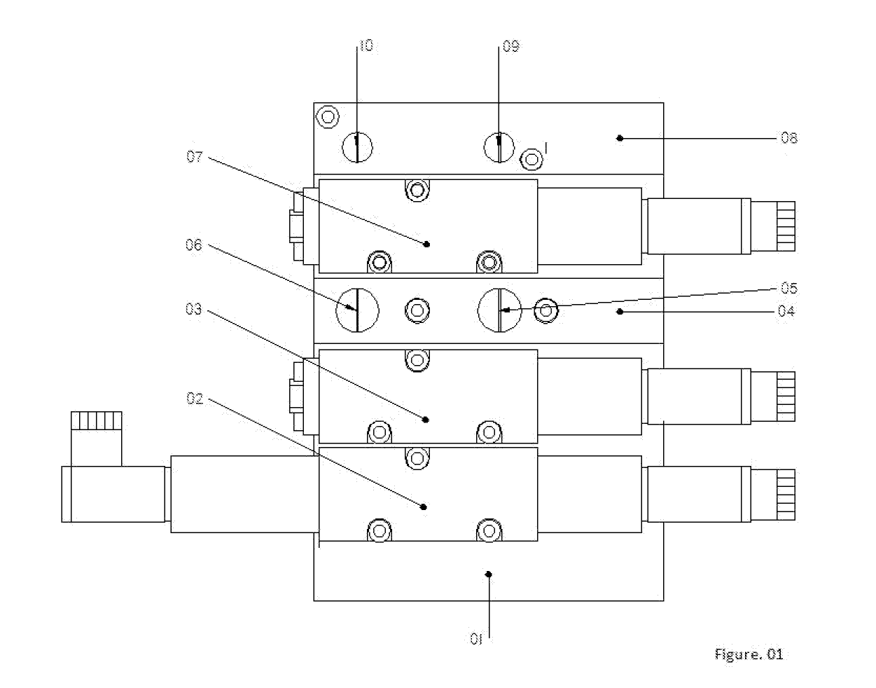

Referring now to the drawings, the embodiment depicted in FIG. 1 illustrates a manifold body 1 with mounted electro-pneumatic valves 2, 3, 7. A five-port, three-position valve 2 is affixed to the manifold body 1 with screws or other suitable fasteners or fastening means. The surface between both the manifold body 1 and the five-port, three-position valve 2 is sealed with a gasket of suitable material or other sealing means.

Still referring to FIG. 1, a five-port, two-position valve 3 is affixed to the manifold body 1. In the embodiment shown, the surface between both the manifold body 1 and the five-port, two-position valve 3 is sealed with a gasket of suitable material. If this valve 3 is not required, a non-ported blank can be fixed in lieu thereof.

Still referring to FIG. 1 embodiment, a primary manually adjusted exhausting air control assembly 4 is affixed to the manifold body 1. Screw type flow restriction valves 5, 6 are adjusted to control the open and close speeds of the pneumatic actuator. If the primary manually adjusted exhausting air control assembly is not required, a non-ported blank can be affixed in lieu thereof.

Still referring to FIG. 1, a five-port, two-position valve 7 is affixed to the manifold body 1. The surface between both the manifold body 1 and the valve 7 may be sealed with a gasket of suitable material. If the valve 7 is not required, a non-ported blank can be affixed in lieu thereof.

Still referring to the FIG. 1 embodiment, a secondary manually adjusted exhausting air control assembly 8 is affixed to the manifold body 1 and screw type flow restriction valves 9, 10 can be adjusted to control the open and close deceleration speeds of the pneumatic actuator.

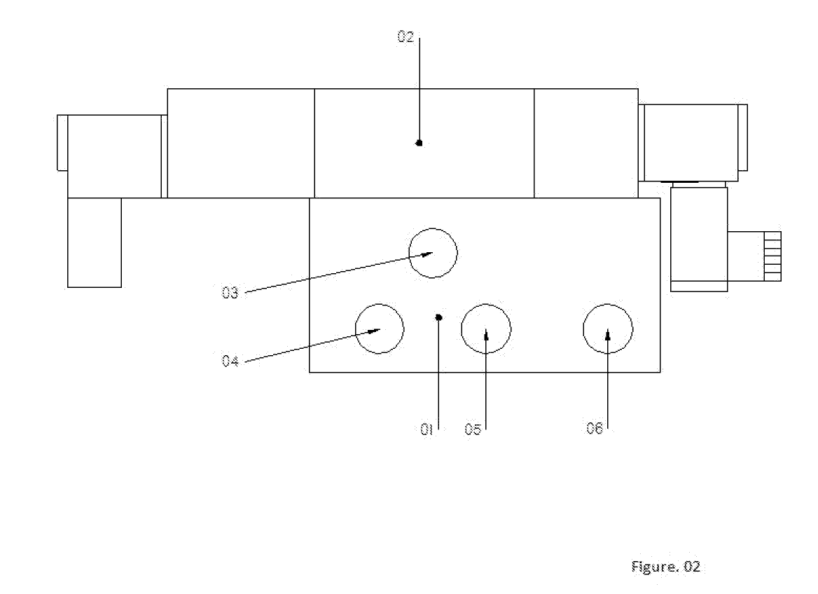

FIG. 2 illustrates port locations where mechanical fittings may be threaded to the manifold body 1. The five-port, three-position valve 2 is shown fixed to the manifold body 1. A regulated source of compressed air is connected to a mechanical fitting at the inlet port 3.

When the directional valve 2 is in a neutral position or stop, compressed air enters at the inlet port 3 and leaves the manifold 1 at both outlet ports 4, 5 to pressurize both sides of the pneumatic actuator.

When the directional valve 2 is actuated to open, pressurized air from the inlet port 3 is directed through the open outlet port 4 pushing one side of the pneumatic actuator. Exhausting air from the other side of the actuator enters at the close outlet port 5. Exhausting air post control circuit is exhausted to atmosphere through a porous silencer at the exhaust outlet port 6.

When the directional valve 2 is actuated to close, pressurized air from the inlet port 3 is directed through the close outlet port 5 pushing one side of the pneumatic actuator. Exhausting air from the other side of the actuator enters at the open outlet port 4. Exhausting air post control circuit is exhausted to atmosphere through a porous silencer at the exhaust outlet port 6.

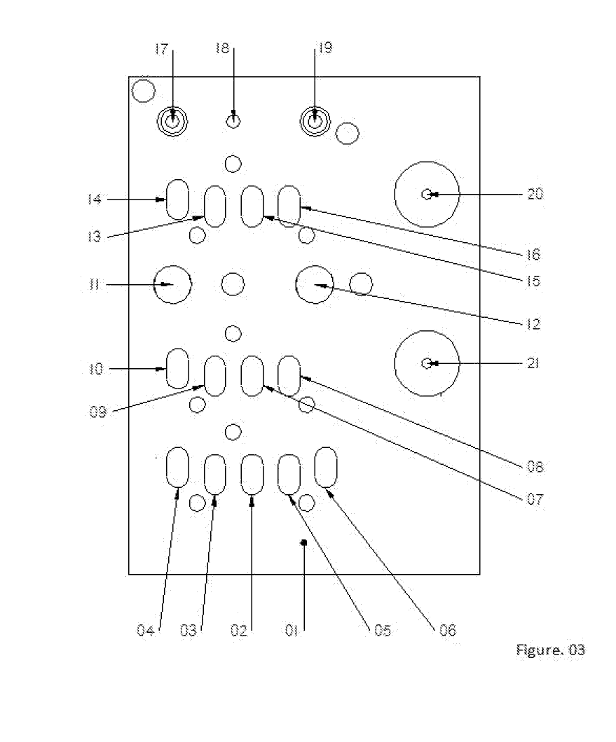

The FIG. 3 embodiment illustrates ports machined at the mating surface of the manifold body 1. In this embodiment, regulated pressurized air enters the directional valve from port 2 and is applied by the directional valve individually or simultaneously to the manifold through ports 3, 5 depending if it is energized to open, close or stop. The regulated pressurized air is also applied to the external pilot supply ports 20, 21 for the acceleration valve and deceleration valve.

In the embodiment shown in FIG. 3, ports 4, 10, 14 along with the primary exhaust restriction valve receiver 11 and the secondary exhaust restriction valve port 17 are connected by an internal passage of the manifold body 1.

Still referring to the FIG. 3 embodiment, ports 6, 8, 16 along with the primary exhaust restriction valve receiver 12 and the secondary exhaust restriction valve port 19 are connected by an internal passage of the manifold body 1.

Still referring to FIG. 3, ports 7, 9, 13, 15 along with the secondary exhaust restriction valve common port 18 are connected by an internal passage of the manifold body 1 to a porous muffler.

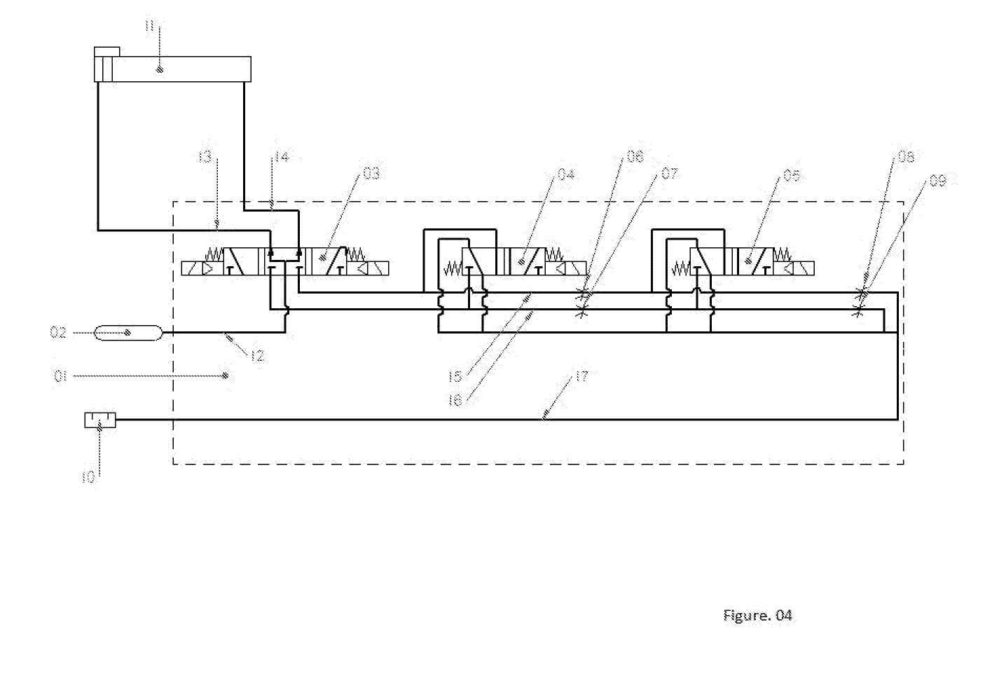

FIG. 4 depicts a pneumatic circuit better illustrating the relationship between the valve body 1 and the modular control valves 3, 4, 5, the primary exhausted air restriction valves 6, 7 and the secondary exhaust restriction valves 8, 9. In this embodiment, the regulated compressed air source 2 is mechanically connected by one airline to the manifold body 1 and a pneumatic actuator 11 is mechanically connected by two airlines to the manifold body 1.

In operation, regulated pressurized air enters the manifold body 1 through an internal passage 12 of the manifold body 1 to the attached five-port, three-position directional valve 3. When in a neutral position the pressurized air is directed by the directional valve 3 through internal passages 13, 14 of the manifold body 1 to the pneumatic actuator 11. Applying pressurized air to both sides of the pneumatic actuator 11 stops the travel of the access mechanism (e.g. a garage door).

If the directional valve 3 is actuated in one direction, pressurized air is allowed through internal passage 13 to the pneumatic actuator 11, exhaust air from the opposing side of the pneumatic actuator 11 is pushed through an internal passage 14 of the valve body 1 to the directional valve 3. Exhaust air from internal passage 14 is directed through the directional valve 3 to an internal passage 15 of the manifold body 1. When the directional valve 3 is actuated in an opposite direction, pressurized air is allowed through internal passage 14 to the pneumatic actuator 11, exhaust air from the opposing side of the pneumatic actuator 11 is pushed through an internal passage 13 of the valve body 1 to the directional valve 3. Exhaust air from internal passage 13 is directed through the directional valve 3 to an internal passage 16 of the manifold body 1.

When the directional valve 4 is not actuated, exhaust air depending on the actuation of directional valve 3 passes through internal passages 15, 16 to primary adjustable exhaust restriction valves 6, 7. The restricted exhaust air flow then continues through extensions of internal passages 15, 16 to directional valve 5 which is typically actuated allowing the exhaust air to internal passage 17, through a porous silencer 10 and out to atmosphere. If the directional valve 5 is not actuated, exhaust air is forced to continue through extensions of internal passages 15, 16 to the secondary adjustable exhaust air restriction valves 8, 9. The secondary exhaust restriction valves 8, 9 further decrease the effect of pressurized air on the pneumatic actuator from internal ports 13 or 14. Exhaust passing through secondary restriction valves 8, 9 continue to internal passage 17, through the porous silencer 10 and out to the atmosphere.

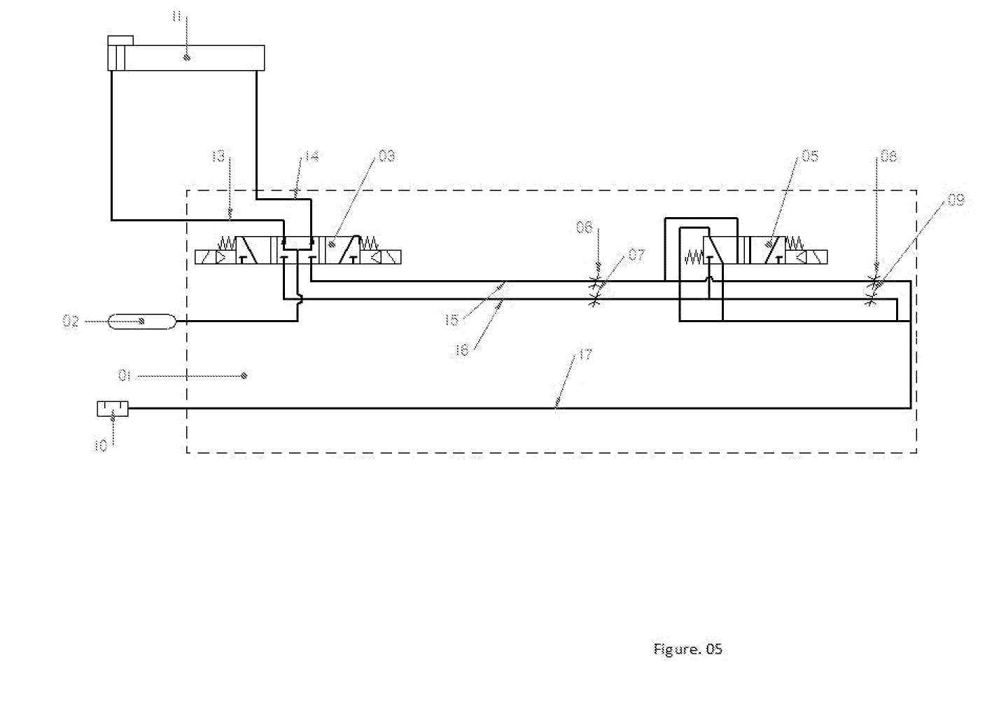

FIG. 5 illustrates the same configurations and functions depicted in FIG. 4, but with the directional valve 4 removed and a non-ported blocking plate affixed in its place to the manifold body 1.

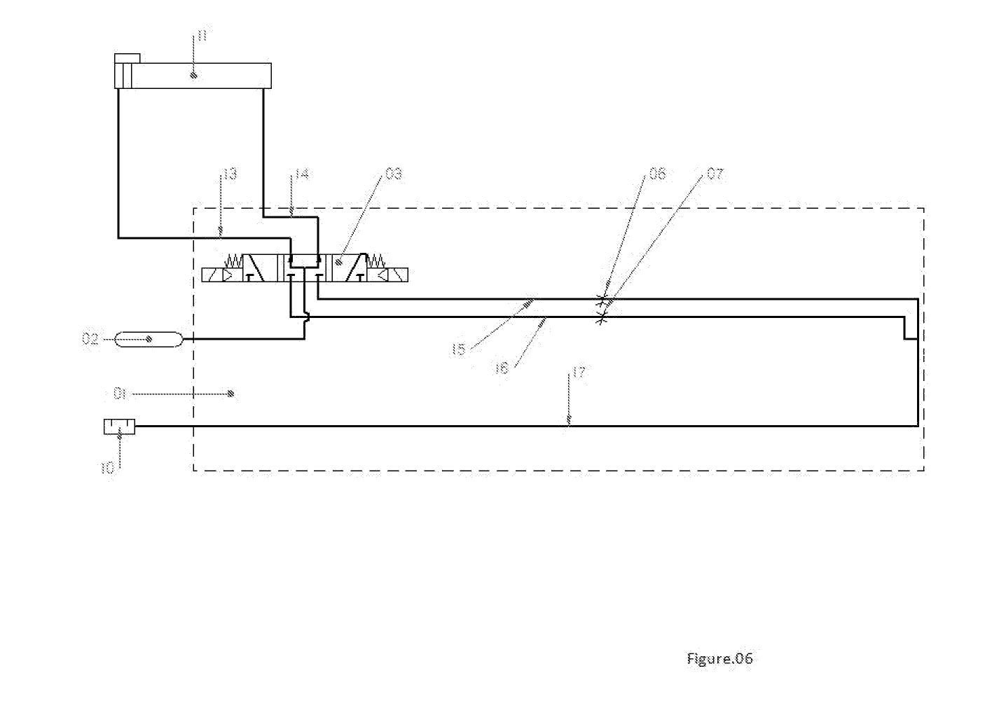

FIG. 6 illustrates the same configurations and functions depicted in FIG. 5 with the addition of the directional valve 5 removed and a ported blocking plate affixed in its place to the manifold body 1. The secondary adjustable exhaust restriction valves 8, 9 are also removed with a non-ported blocking plate affixed to the manifold body 1.

While one or more embodiments of this invention have been described above, it will be evident to those skilled in the art that changes and modifications can be made therein without departing from the essence of this invention. All such modifications are believed to be within the sphere and scope of the invention as defined by the claims appended hereto.

We claim:

1. A pneumatic manifold for controlling a pneumatic actuator to control an access mechanism, comprising:
internal and external porting machined in a specific sequence for pressurized and exhausting air control, and
a plurality of electro-pneumatic valves fastened and sealed to the positions of exterior porting, to complete a controlled pneumatic circuit.

2. The pneumatic manifold of claim 1 wherein the plurality of electro-pneumatic valves comprise:
a primary 5 port, 3 position inlet open to cylinder ports valve for enabling directional control of pressurized air and stop control of the pneumatic actuator;
a secondary 5 port 2 position valve for diverting exhausting air, before the primary individual manually adjustable restriction valves from the controlled pneumatic circuit, to the atmosphere in order to improve initial acceleration upon movement of the pneumatic actuator in either direction; and
an additional secondary 5 port 2 position valve for diverting exhausting air from the controlled pneumatic circuit to the secondary individual manually adjustable flow restriction valves in order to decelerate the pneumatic actuator in either direction.
